(19) United States
(12) Patent Application Publication
(10) Pub. No.: US 2012/0005460 A1
(43) Pub. Date: Jan. 5, 2012

(54) INSTRUCTION EXECUTION APPARATUS, INSTRUCTION EXECUTION METHOD, AND INSTRUCTION EXECUTION PROGRAM

(75) Inventor: Hiroshi Inoue, Kanagawa (JP)

(73) Assignee: INTERNATIONAL BUSINESS MACHINES CORPORATION, Armonk, NY (US)

(21) Appl. No.: 13/165,850

(22) Filed: Jun. 22, 2011

(30) Foreign Application Priority Data
Jun. 30, 2010 (JP) 2010-148579

(51) Int. Cl. G06F 9/30

(52) U.S. Cl. 712/226; 712/E09.028

(57) ABSTRACT

An apparatus, method, and program product for monitoring execution of a program, reducing overhead and not changing the behavior of the program. The apparatus performs additional processing which requires a memory area upon execution of a specific instruction to be executed by a predetermined execution system on a computer. The system includes a memory reservation unit reserving the memory area for the additional processing, an instruction replacement unit copying the specific instruction to the reserved memory area and replacing the specific instruction with a special-purpose instruction, an additional processing execution unit acquiring the memory area, and a replaced instruction execution unit performing the same processing as that performed by the specific instruction.

### CROSS-REFERENCE TO RELATED APPLICATIONS

This application claims priority under 35 U.S.C. §119 from Japanese Patent Application No. 2010-148579 filed Jun. 30, 2010, the entire contents of which are incorporated herein by reference.

### BACKGROUND OF THE INVENTION

1. Field of the Invention

The present invention relates the allocation of resources of a computer. In particular, the present invention relates to a technique, apparatus, and programming product for performing additional processing requiring a memory area so as to monitor execution of a specific instruction in an instruction stream.

2. Description of Related Art

Hitherto, in a processing system, performing dynamic compilation and binary translation for each trace, monitoring of execution of a program has been performed to generate a trace.

For example, Vasanth Bala et al., in “Dynamo: A Transparent Dynamic Optimization System”, ACM SIGPLAN Notices, Volume 35, pp. 1-12, May 2000 discloses a technique for allocating a counter variable to each backward branch instruction in a program and counting the number of executions of each jump so as to monitor the number of executions of a loop. According to the technique disclosed in Bala, the address of a counter variable is acquired by referring to a hash table, using the address of a jump instruction at the time of jumping backward as a key.

Moreover, Collins et al., in “A Loop-aware Search Strategy for Automated Performance Analysis”, In High Performance Computing and Communications (HPCC-05), Sorrento, Italy, September 2005 discloses a technique for rewriting a program to be monitored to change a jump target of a jump instruction to code for profiling and performing calculation of a counter using the code.

Moreover, Japanese Unexamined Patent Application Publication No. 9-244717 exists in relation to a technique for rewriting a part of a program in operation. This reference discloses a technique for writing, to the head of an old program to be changed, the address of a new program storage area where a new program is stored and writing, to the end of the new program storage area, the address of a place next to an old program storage area as a jump target address when a rewrite conditions is satisfied.

Japanese Unexamined Patent Application Publication No. 2005-322232, which is related to U.S. Pat. No. 7,437,536, deals with to a technique for acquiring an address from a base value and the value of an offset from the base value.

### BRIEF SUMMARY OF THE INVENTION

A first aspect of the present invention provides an instruction execution apparatus performing additional processing requiring a memory area on execution of a specific instruction to be monitored included in an instruction stream including instructions to be executed by a predetermined execution system on a computer.

The instruction execution apparatus includes a memory reservation unit reserving the memory area for the additional processing for the specific instruction included in the instruction stream read on a memory, an instruction replacement unit copying the specific instruction to the reserved memory area and replacing the specific instruction with a special-purpose instruction performing the additional processing and identification information for identifying a location of the memory area, an additional processing execution unit acquiring, upon reading the special-purpose instruction in the instruction stream, the memory area from the identification information having been subjected to replacement together with the special-purpose instruction and performing the additional processing using the memory area, and a replaced instruction execution unit performing same processing as processing performed by the specific instruction referring to the specific instruction copied to the acquired memory area.

According to another aspect of the invention, an instruction execution program product to be executed on a computer, the instruction execution program product performing additional processing requiring a memory area on execution of a specific instruction to be monitored included in an instruction stream including instructions to be executed by a predetermined execution system on the computer, the instruction execution program product causing the computer to execute the following steps: reserving the memory area for the additional processing for the specific instruction included in the instruction stream read on a memory; copying the specific instruction to the reserved memory area and replacing the specific instruction with a special-purpose instruction performing the additional processing and identification information for identifying a location of the memory area; acquiring, upon reading the special-purpose instruction in the instruction stream, the memory area from the identification information having been subjected to replacement together with the special-purpose instruction and performing the additional processing using the memory area; and performing same processing as processing performed by the specific instruction referring to the specific instruction copied to the acquired memory area.

In a further aspect of the invention, an instruction execution method to be executed by a computer, the instruction execution method performing additional processing requiring a memory area on execution of a specific instruction to be monitored included in an instruction stream including instructions to be executed by a predetermined execution system on the computer, the instruction execution method including the following steps: reserving the memory area for the additional processing for the specific instruction included in the instruction stream read on a memory; copying the specific instruction to the reserved memory area and replacing the specific instruction with a special-purpose instruction performing the additional processing and identification information for identifying a location of the memory area; acquiring, upon reading the special-purpose instruction in the instruction stream, the memory area from the identification information having been subjected to replacement together with the special-purpose instruction and performing the additional processing using the memory area; and performing same processing as processing performed by the specific instruction referring to the specific instruction copied to the acquired memory area.

According to the present invention, since a specific instruction to be monitored in an instruction stream read into a memory is replaced with a special-purpose instruction performing additional processing and identification information for identifying the location of an additional memory area for the special-purpose instruction and is copied to the additional memory area, a hash table need not be referred to for acquiring the location of the additional memory area, and the overhead can be reduced.

Moreover, according to the present invention, when the special-purpose instruction has been read from the instruction stream, after the additional processing is performed using the additional memory area, processing similar to the specific instruction in the area is performed referring to the instruction. Thus, the behavior of an original program does not change.

Other characteristics and advantages of the invention will become obvious in combination with the description of accompanying drawings, wherein the same number represents the same or similar parts in all figures.

### BRIEF DESCRIPTION OF DRAWINGS

FIG. 1 is a block diagram showing the functional components of a computer system to which an instruction execution method according to an embodiment of the present invention can be applied.

FIG. 2 is a functional block diagram of an instruction execution apparatus 200 according to a first embodiment of the present invention.

FIG. 3 is a diagram showing exemplary rewriting of bytecode by an instruction execution apparatus according to an embodiment of the present invention.

FIG. 4(a) shows exemplary pseudo code of a known handler of a jump instruction according to an embodiment of the present invention.

FIG. 4(b) shows exemplary pseudo code of a special-purpose instruction handler according to an embodiment of the present invention.

FIG. 5 is a flowchart showing the flow of a process by the instruction execution apparatus 200 according to an embodiment of the present invention.

FIG. 6 is a flowchart showing an embodiment of the flow of memory reservation and instruction replacement operations (S505) shown in FIG. 5.

FIG. 7 is a flowchart showing an embodiment of the flow of an operation (S515) by a special-purpose instruction handler 215 shown in FIG. 5.

FIG. 8 is a functional block diagram of an instruction execution apparatus 800 according to another embodiment of the present invention.

FIG. 9 is a flowchart showing the flow of a process by the instruction execution apparatus 800 according to another embodiment of the present invention.

FIG. 10 is a flowchart showing an embodiment of the flow of an operation (S910) by a specific instruction handler 805 shown in FIG. 9.

FIG. 11 is a functional block diagram of an instruction execution apparatus 1100 according to yet another embodiment of the present invention.

FIG. 12 is a flowchart showing an embodiment of the flow of an operation by a specific instruction handler 1105.

FIG. 13 is a graph showing the results of experiments in comparison of a prior art and an embodiment of the present invention regarding overhead due to a counter operation.

FIG. 14 shows exemplary hardware components of a computer 50 according to an embodiment of the present invention.

### DETAILED DESCRIPTION OF THE PREFERRED EMBODIMENTS

The technique disclosed in Bala et al. allows monitoring of execution of a program without changing the behavior of the program but has a problem in that the overhead of reference to a hash table is high. On the other hand, the techniques disclosed in Japanese Unexamined Patent Application Publication No. 9-244717 and Japanese Unexamined Patent Application Publication No. 2005-322232 do not require reference to a hash table for acquiring the address of a counter. Thus, the overhead is lower than that in the technique in Bala.

However, the techniques disclosed in 9-244717 and 2005-322232 rewrite an original program to change the program to other code and thus change the behavior of the program. Even when the code of a rewritten part is saved to another place, in turn, the behavior of the program is changed by an increase in the number of executable instructions. Moreover, these techniques cannot do more than what can be described in an original programming language.

The present invention is made to improve the aforementioned disclosures. The basic principle of the invention is to provide a technique for monitoring execution of a program, reducing overhead and not changing the behavior of the program. Detailed description of the invention is made in combination with the following embodiments.

Techniques for using a trace as a unit of processing in, for example, language runtime systems performing dynamic compilation and binary translation, have become important. A trace represents an instruction stream that is determined by dynamically monitoring execution and is frequently executed. In a trace-based processing system, in general, a counter is provided for each backward branch instruction, and the number of executions is counted so as to find a loop that is executed many times and set the loop as a candidate for which a trace is generated. In this case, in the prior arts, since a counter is managed using a hash table in which the address of a jump instruction is a key, the overhead of looking up a hash becomes significant, as described above.

It is an object of the present invention to reduce the overhead of monitoring execution so as to generate a trace without changing the behavior of a program in such a trace-based processing system. For the sake of easy understanding, a case in which the present invention is applied to an interpreter in a virtual machine will be described.

Moreover, it is assumed that monitoring of execution for generating a trace is performed by a counter operation of counting the number of executions of a backward branch instruction. However, it should be noted that the application of the present invention is not limited to an interpreter in a virtual machine, and the present invention can be also applied to, for example, a binary translator emulator executing a binary for another machine and any additional processing that requires a memory area and is performed on execution of a specific instruction to be monitored.

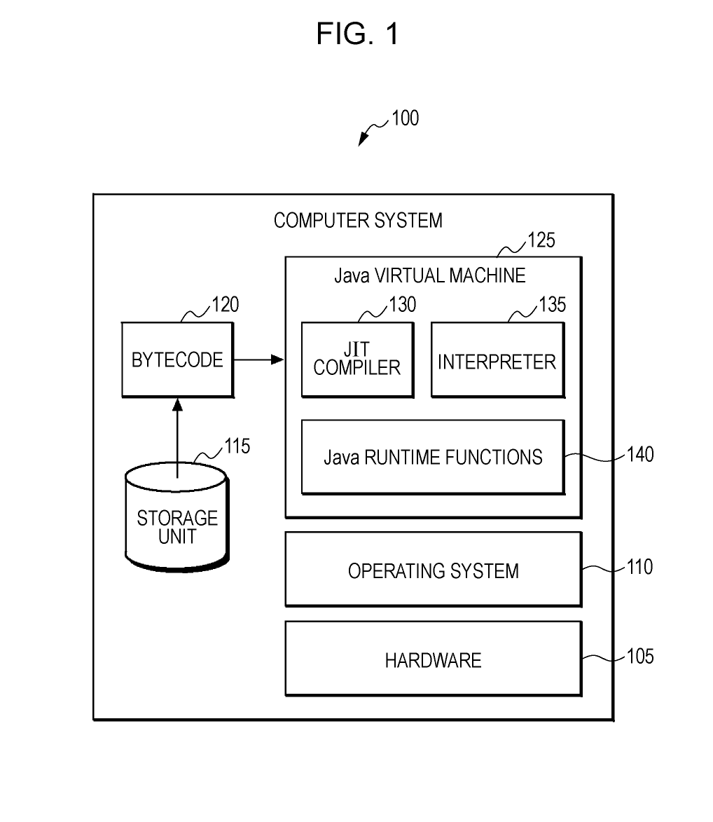

FIG. 1 shows the configuration of a computer system 100 to which the present invention can be applied. The computer system 100 includes general computer hardware 105 including a central processing unit (CPU), a memory, their peripheral circuits, and the like (not shown), an operating system (OS) 110, a virtual machine 125, and a storage unit 115. The virtual machine 125 can be, for example, a Java® virtual machine available from Sun (registered trademark) Microsystems. The following description will be given, assuming that the virtual machine 125 is a Java® virtual machine.

The Java® virtual machine 125 is installed in the storage unit 115 in advance via, for example, a communication network and a recording medium (not shown) and is loaded into the memory of the hardware 105 at system startup to operate on the OS 110. The Java® virtual machine 125 executes bytecode 120 sent from a computer such as a server computer via a communication network or the bytecode 120 supplied to the storage unit 115 via a recording medium.

Java® runtime functions 140 are a group of functions processing a part of the Java® language specification other than the specification of bytecode. For example, the Java® runtime functions 140 reserve an area in the memory for loading bytecode having not been loaded into the memory from, e.g., the storage unit 115 to the memory or creating an object.

A JIT compiler 130 performs dynamic compilation of the bytecode 120 and generates bytecode in machine code form that can be executed by the CPU of the hardware 105. The generated bytecode in machine code form is executed by the CPU of the hardware 105.

An interpreter 135 processes the bytecode 120 one instruction at a time to perform processing defined for each bytecode. Moreover, the interpreter 135 performs operations other than bytecode operations via the Java® runtime functions 140, for example, reading bytecode from the storage unit 115 such as a hard disk drive or a communication network and requesting bytecode from the OS 110.

Moreover, the interpreter 135 includes a component necessary to implement a bytecode execution method according to the present invention and performs additional processing requiring a memory area on execution of a specific instruction to be monitored included in a bytecode stream read into the memory.

Specifically, for a specific instruction to be monitored included in a bytecode stream read into the memory, the interpreter 135 reserves an additional memory area for additional processing, copies the specific instruction to a part of the memory area, and replaces the specific instruction in the bytecode stream with a special-purpose instruction performing the additional processing and identification information for indentifying the location of the additional memory area.

Moreover, when the special-purpose instruction has been read from the bytecode stream, the interpreter 135 acquires the memory area on the basis of the identification information, with which the specific instruction has been replaced together with the special-purpose instruction, performs the additional processing using another part of the additional memory area, and further performs processing similar to the specific instruction referring to the specific instruction copied to the memory area.

In this case, the series of operations from reservation of the additional memory to replacement of the instruction can be performed in response to reading the bytecode stream including the specific instruction into the memory or can be performed in response to execution of the specific instruction. The description will be given below in turn, assuming that the former is a first embodiment, and the latter is a second embodiment.

Moreover, in the following description, it is assumed that a specific instruction is a backward branch instruction, as described above.

Lastly, it is assumed that additional processing requiring a memory area to be performed on execution of a backward branch instruction is a counter operation of counting the number of executions of a backward branch instruction.

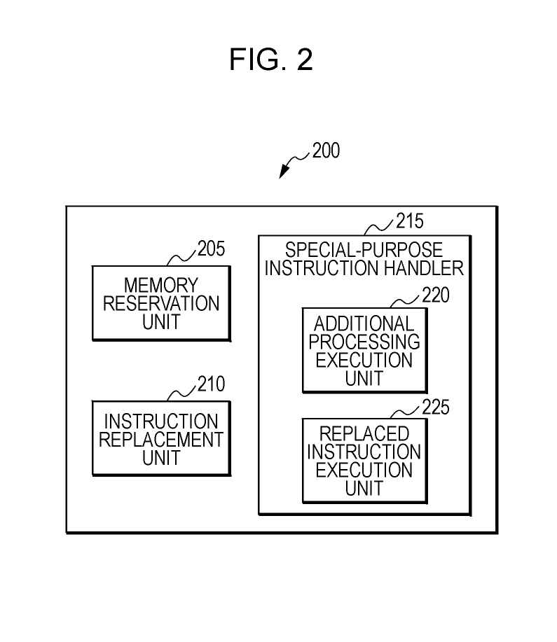

FIG. 2 is an embodiment of a functional block diagram of an interpreter serving as an instruction execution apparatus. The interpreter serving as the instruction execution apparatus 200 according to the first embodiment includes a memory reservation unit 205, an instruction replacement unit 210, and a special-purpose instruction handler 215. The special-purpose instruction handler 215 includes an additional processing execution unit 220 and a replaced instruction execution unit 225.

When a class file has been loaded into the memory, for each method included in the class file, the memory reservation unit 205 reserves, as a memory area for the additional processing, an array including as many elements as the number of one or more specific instructions included in the bytecode stream of the method. Thus, in response to loading of the class file, the memory reservation unit 205 counts the number of pieces of bytecode corresponding to a backward branch instruction, for example, Java® bytecode such as goto, ifeq, and if_icmpeq, by scanning the bytecode stream of the method.

Each element in the array is allocated to a corresponding one of the one or more instructions to jump backward included in the method. A part of the memory area of the element is used as a work area for the additional processing, i.e., a counter. Moreover, another part of the memory area of the element is used as an area for copying a specific instruction to which the element is allocated, i.e., a backward branch instruction, and an offset to a jump target. Thus, the size of each element of an array in the embodiments is at least eight bytes, the sum of the number of bytes of a counter (for example, four bytes) and the size of information of a backward branch instruction (for example, two bytes for a jump instruction and two bytes for an offset to a jump target).

Moreover, the memory reservation unit 205 stores the location information of a reserved array, for example, a pointer to the array, in association with a corresponding method. For example, the memory reservation unit 205 can store the location information of an array in a method structure storing the information of each method (for example, a name and access control information). The memory reservation unit 205 can reserve an array for each class instead of each method. In this case, the memory reservation unit 205 can store the location information of an array in a class structure storing the information of each class (for example, a list of names, methods, variables, and the like). However, when the number of methods included in a class is large, an operation is preferably performed for each method. This is because the length of an index specifying an element of an array used by the instruction replacement unit 210 described below can exceed two bytes. In this case, it is difficult to embed the index information in an original bytecode stream.

The instruction replacement unit 210 copies each of one or more specific instructions included in the bytecode stream of a method to a corresponding element of an array reserved by the memory reservation unit 205. In the embodiments, since a specific instruction is a backward branch instruction, the instruction replacement unit 210 copies a backward branch instruction, together with an offset to a jump target, to a corresponding element of an array. Thus, in response to reservation of a memory by the memory reservation unit 205, the instruction replacement unit 210 scans the bytecode stream of each method in a class file.

When pieces of bytecode corresponding to a backward branch instruction, for example, Java® bytecode such as goto, ifeq, and if_icmpeq, have been detected, the memory reservation unit 205 copies the pieces of bytecode to corresponding elements of an array in turn. In the following description, it is shown by adding JB to the head of the name of Java® bytecode, for example, JBgoto, that the bytecode is Java® bytecode.

Moreover, the instruction replacement unit 210 replaces each of one or more specific instructions included in the bytecode stream of a method, i.e., instructions to jump backward, with identification information for indentifying the location of a memory area allocated to the specific instruction and a special-purpose instruction performing the additional processing. In this case, a special-purpose instruction performing the additional processing represents a special-purpose instruction that is defined in advance so as to be processed by the interpreter serving as the instruction execution apparatus 200 and causes the interpreter to perform the additional processing on execution of a specific instruction to be replaced with the special-purpose instruction and processing similar to the specific instruction to be replaced. In the following description, it is assumed that the name of such a special-purpose instruction is JBbackedge.

Moreover, in the embodiments, an element of an array is allocated to each backward branch instruction, as described above. In this case, the instruction replacement unit 210 can use the index of an array as identification information for identifying the location of an allocated memory area. The instruction replacement unit 210 can further replace offset information indicating a jump target of a backward branch instruction with the index information of an array.

Alternatively, the instruction replacement unit 210 can embed the index information of an array in the name of a special-purpose instruction and replace a backward branch instruction in a bytecode stream with the special-purpose instruction. For example, when the index of an element of an array allocated to a target backward branch instruction in a bytecode stream is 2, the instruction replacement unit 210 can replace the target backward branch instruction in the bytecode stream with JBbackedge2.

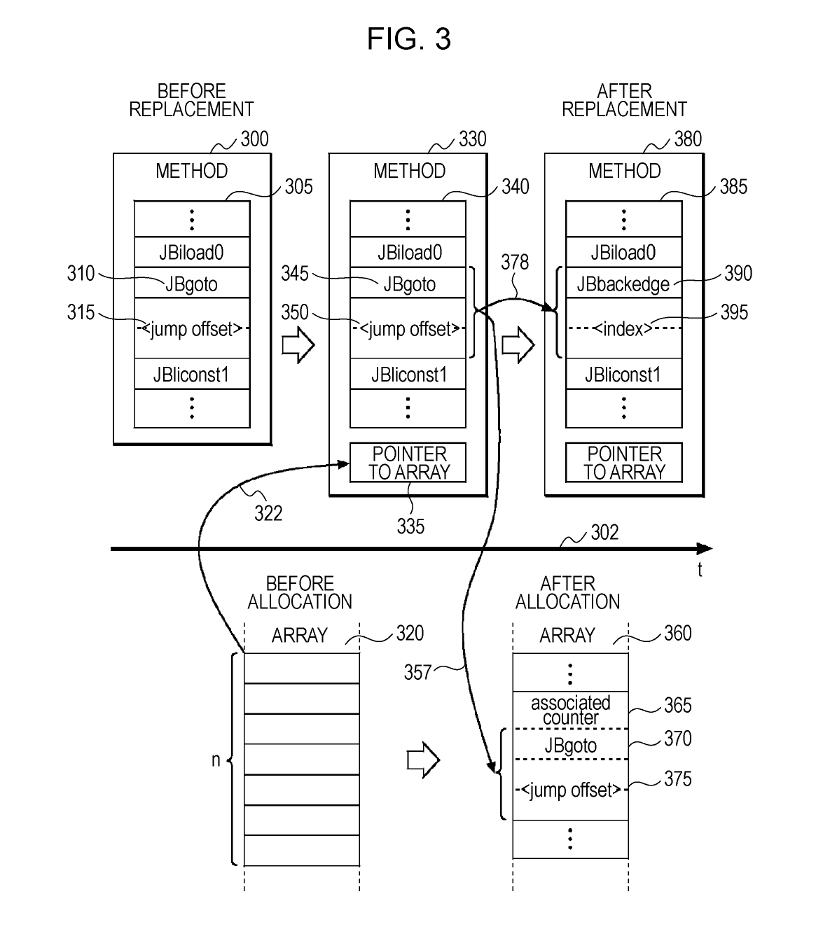

Referring to FIG. 3, reservation of an array by the memory reservation unit 205 and copying and replacement of an instruction by the instruction replacement unit 210 will now be described. The abscissa t 302 of FIG. 3 represents the time flow, and a rectangle referred to by a number 300 represents a method loaded into the memory. Methods 300, 330, and 380 at the top of FIG. 3 show the same method though the states are different. Similarly, arrays 320 and 360 at the bottom of FIG. 3 show the same array though the states are different. The method 300 includes a bytecode stream 305, and JBgoto 310, together with an offset (<jumpoffset>) 315, is included in the bytecode stream 305 as a backward branch instruction.

When the method 300 has been loaded into the memory, the memory reservation unit 205 counts the number n of instructions to jump backward, such as JBgoto 310, by scanning the bytecode stream 305. Then, the memory reservation unit 205 reserves, on the memory, the array 320 including as many elements as the acquired number n of instructions to jump backward, as shown in FIG. 3, and stores the location information of the reserved array 320 in a method structure 335 of the method 330, as indicated by an arrow 322.

Then, the instruction replacement unit 210 copies each backward branch instruction detected by scanning a bytecode stream 340 in the method 330 to a corresponding element of the array 360. In this case, an element of an array to be allocated can be determined, for example, from the head of the array in the order in which instructions to jump backward have been detected. In FIG. 3, an instruction JBgoto 345 to jump backward and an offset (<jumpoffset>) 350 are copied respectively to parts 370 and 375 of an allocated element of the array 360, as indicated by an arrow 357. Moreover, since another part 365 of the element is an area to be used as a counter by a special-purpose instruction JBbackedge 390 described below, the instruction replacement unit 210 stores, in the element 365, a counter variable to which an initial value of zero is set.

Subsequently, the instruction replacement unit 210 replaces the copied instruction JBgoto 345 to jump backward and the copied offset (<jumpoffset>) 350 in the bytecode stream 340 respectively with the special-purpose instruction JBbackedge 390 and index information (<index>) 395 for identifying the location of an allocated element of an array, as indicated by an arrow 378. Copying and replacement of an instruction by the instruction replacement unit 210 are repeated until any backward branch instruction having not been processed disappears from the bytecode stream 340 in the method 330.

Returning to FIG. 2, the special-purpose instruction handler 215 is a handler for a special-purpose instruction that is called in response to a special-purpose instruction in a bytecode stream. The special-purpose instruction handler 215 includes the additional processing execution unit 220 and the replaced instruction execution unit 225.

When the special-purpose instruction handler 215 has been called, the additional processing execution unit 220 acquires a memory area on the basis of identification information in a bytecode stream, together with the aforementioned special-purpose instruction, having replaced a specific instruction and performs the additional processing on the replaced specific instruction using the memory area. A specific case where the index information of an array as identification information has replaced the offset information (for example, two bytes of information) of a backward branch instruction will be considered. In this case, it is assumed that the location information of the body of the array, for example, the pointer information of the array, is stored in a method structure.

In the aforementioned case, the additional processing execution unit 220 reads, as the index information of the array, the two bytes following the special-purpose instruction read from the bytecode stream. Moreover, the additional processing execution unit 220 acquires the address of the head of the array by reading the pointer information of the array from the method structure. The location of the target memory area is acquired by adding the product of the index information and the size of an element to the address of the head of the array. The additional processing execution unit 220 counts the number of executions of the backward branch instruction using the acquired memory area as a counter variable. In this case, even when the index information is embedded in the special-purpose instruction, the target memory area can be acquired in a similar manner.

The replaced instruction execution unit 225 performs, referring to the replaced specific instruction copied to the memory area acquired by the additional processing execution unit 220, the same processing as processing performed by the specific instruction.

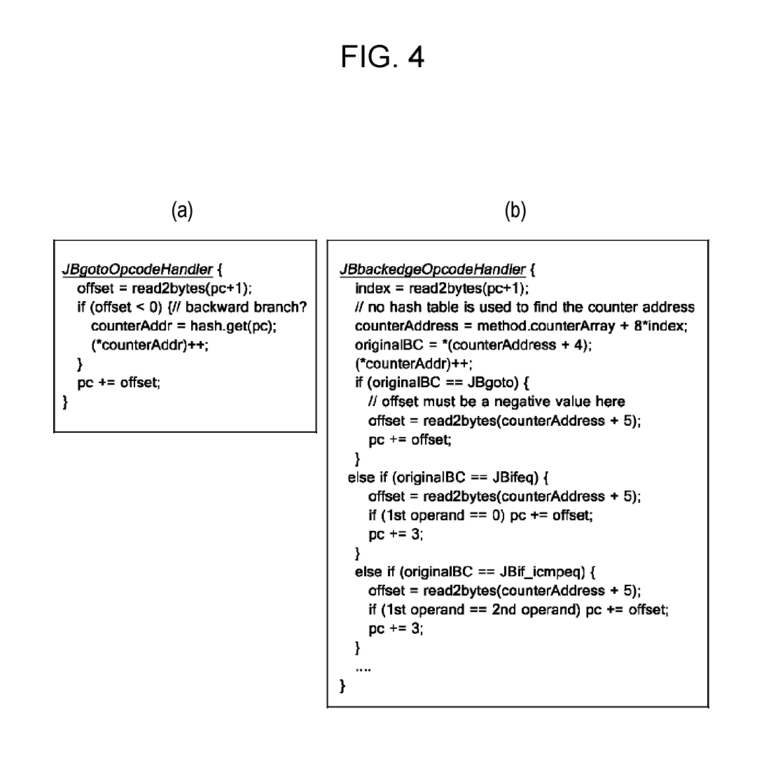

FIG. 4 shows the pseudo code of the special-purpose instruction handler 215. For a comparison purpose, FIG. 4(a) shows the pseudo code of a known handler in which a counter is managed using a hash table in which the address of a jump instruction is a key. In this case, PC described in the code is a program counter. When the known handler is called, PC points to the address of a jump instruction.

At the first line of the code, two bytes from an address following an address pointed to by PC are read and set to offset as the offset value of a jump instruction. At the second line of the code, an expression offset<0 is examined, and it is determined whether the jump instruction pointed to by PC is a backward branch instruction. When the jump instruction pointed to by PC is a backward branch instruction, the following third to fourth lines of the code are executed. At the third line of the code, a hash table is referred to using PC, i.e., the address of the jump instruction, as an argument, and the address of the counter as the result is set to counterAddr. At the fourth line of the code, the value of the counter is incremented by one. At the last sixth line of the code, the value of offset is added to PC to set the address of a jump target to PC.

FIG. 4(b) shows an example of pseudo code of the special-purpose instruction handler 215 of the present invention. In this case as well, PC described in the code is a program counter. When the special-purpose instruction handler 215 of the present invention is called, PC points to the address of a jump instruction. At the first line of the code, two bytes from an address following an address pointed to by PC are read and set to index as index information indicating an element of an array allocated to a backward branch instruction replaced with a special-purpose instruction. At the third line of the code, 8*index is added to the starting address of the array stored in a method structure, and the sum is set to counterAddress as the starting address of the element of the array. In this case, it is assumed that the size of an element is eight bytes, the sum of four bytes used as the counter and four bytes used as a place to which the bytecode information of the original jump instruction is copied.

At the fourth line of the code, the starting address of the original bytecode information is acquired by adding four bytes to the starting address counterAddress of the element of the array, and information existing at the address is set to originalBC as the original bytecode information. At the fifth line of the code, the value of the counter is incremented by one using counterAddress. In if statements at the sixth and following lines, the type of the replaced backward branch instruction is determined by comparing originalBC with instructions to jump backward (for example, JBgoto, JBifeq, and JBif_icmpeq), and processing similar to the determined type of the jump instruction is performed. For example, when the original bytecode originalBC is JBgoto, at the eighth line of the code, two bytes from an address (counterAddress+5) are read and set to offset as offset information indicating the jump target of JBgoto. Then, at the ninth line of the code, the value of offset is added to PC to set the address of the jump target to PC.

On the other hand, when the original bytecode originalBC is JBifeq, at the twelfth line of the code, two bytes from the address (counterAddress+5) are read and set to offset as offset information indicating the jump target of JBifeq. Then, at the thirteenth line of the code, it is examined whether the first operand is zero. When the first operand is zero, the value of offset is added to PC to set the address of the jump target to PC. When the first operand is not zero, three is added to PC to proceed to the next operation.

Moreover, when the original bytecode originalBC is JBif_icmpeq, at the seventeenth line of the code, two bytes from the address (counterAddress+5) are read and set to offset as offset information indicating the jump target of JBif_icmpeq. Then, at the eighteenth line of the code, it is examined whether the first operand is equal to the second operand. When the first operand is equal to the second operand, the value of offset is added to PC to set the address of the jump target to PC. When the first operand is not equal to the second operand, three is added to PC to proceed to the next operation. A backward branch instruction other than those described above can be also processed in a similar manner.

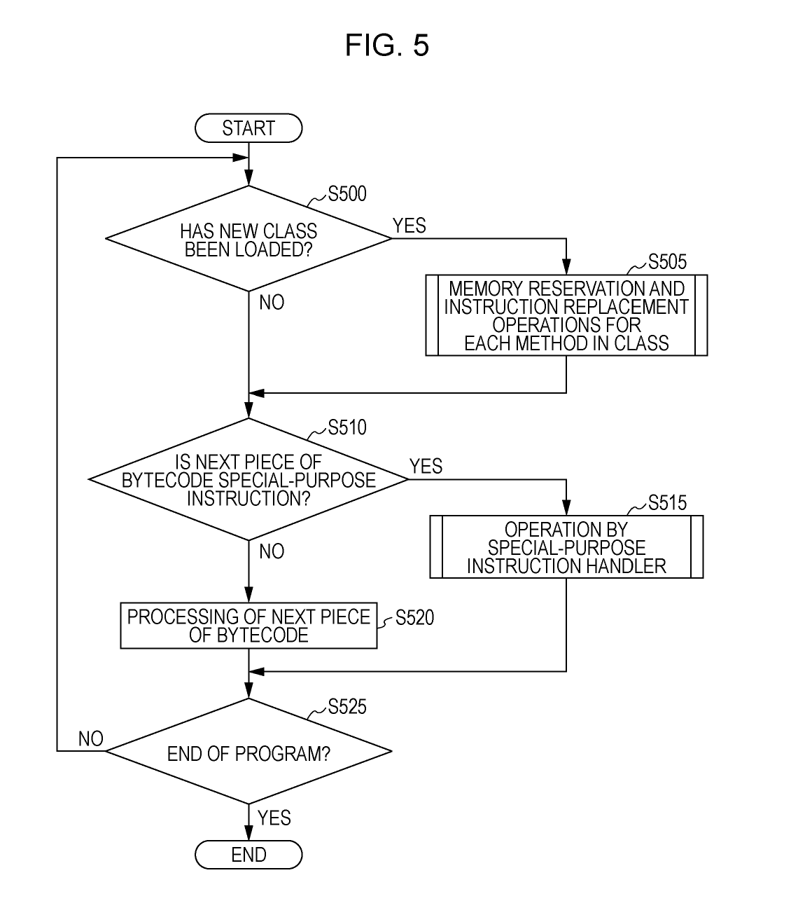

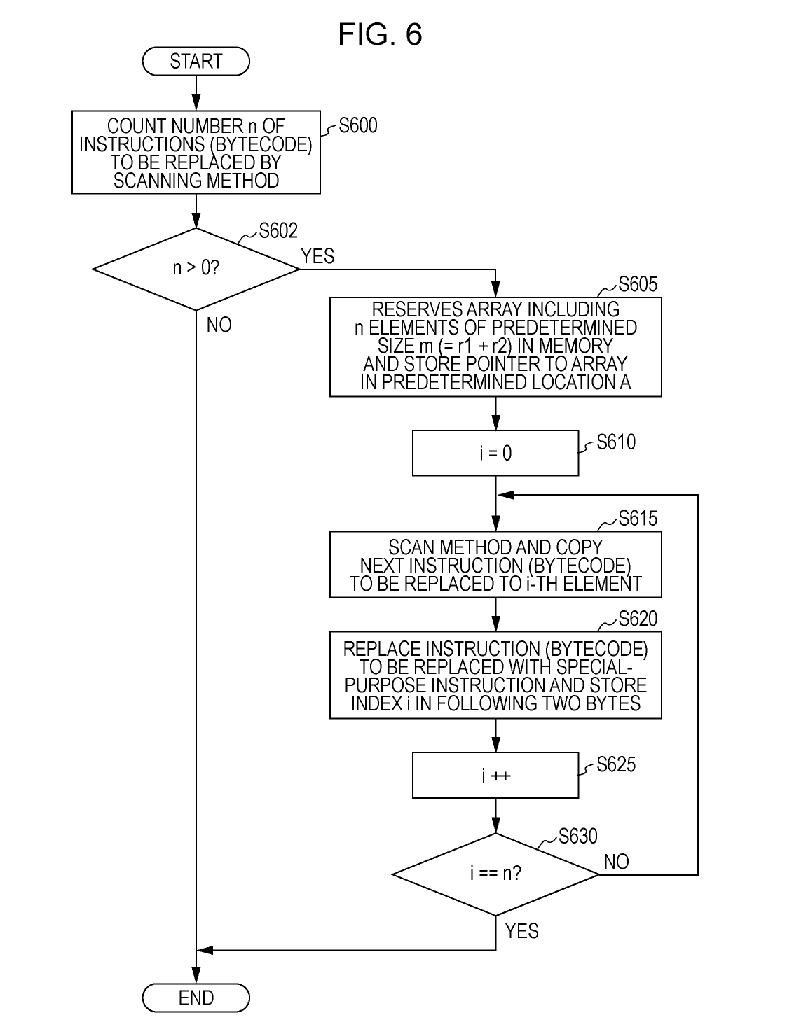

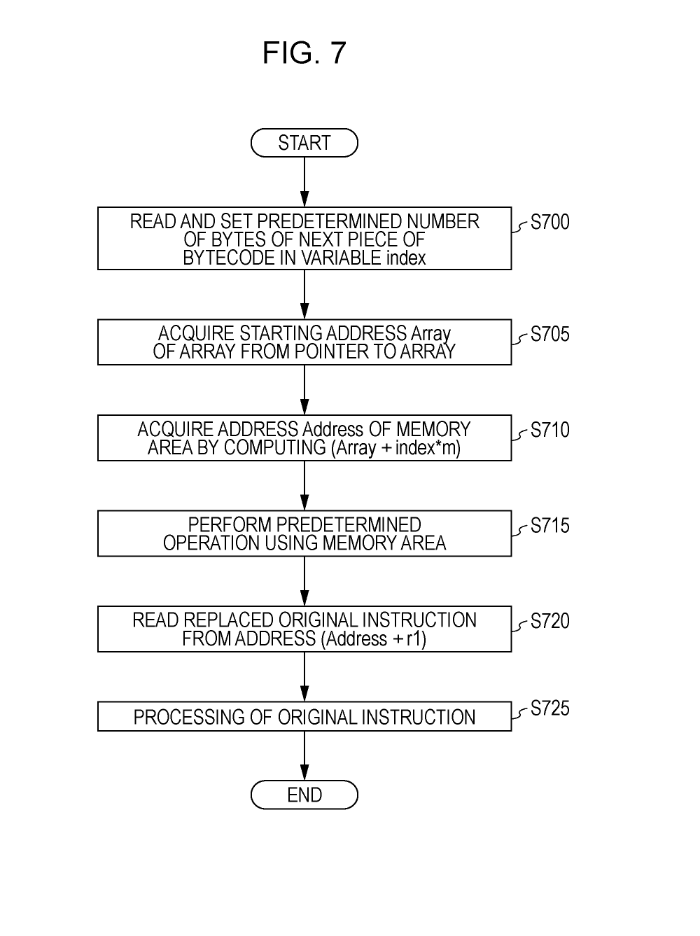

The flow of a process performed by the interpreter serving as the instruction execution apparatus 200 according to the first embodiment of the present invention will next be described referring to FIGS. 5 to 7. FIG. 5 is a flowchart showing the overall flow of the process for executing bytecode by the instruction execution apparatus 200 according to the first embodiment of the present invention. FIG. 6 is a flowchart showing the flow of memory reservation and instruction replacement operations (S505) shown in FIG. 5. FIG. 7 is a flowchart showing the flow of an operation (S515) by a special-purpose instruction handler shown in FIG. 5.

The process shown in FIG. 5 is started from step 500 where the instruction execution apparatus 200 determines whether a new class file has been loaded into the memory. When a new class file has been loaded (step 500: YES), the process proceeds to step 505 where the memory reservation unit 205 performs memory reservation and instruction replacement operations for each method in the class file. The details of the operations by the memory reservation unit 205 will be described below referring to FIG. 6.

On the other hand, when no new class file has been loaded in step 500 (step 500: NO), the process proceeds to step 510 where the instruction execution apparatus 200 reads the next piece of bytecode from a bytecode stream on the memory and determines whether the piece of bytecode is a special-purpose instruction. The next piece of bytecode in a case where the instruction execution apparatus 200 first performs step 510 is the first piece of bytecode in a method included in a class file on the memory.

When the read piece of bytecode is a special-purpose instruction in step 510, the instruction execution apparatus 200 processes the special-purpose instruction by calling a special-purpose instruction handler (step 515). On the other hand, when the read piece of bytecode is not a special-purpose instruction in step 510, the instruction execution apparatus 200 performs an operation defined in the piece of bytecode (step 520). Then, the instruction execution apparatus 200 determines whether the next piece of bytecode exists, i.e., the end of the program has been reached (step 525). When the end of the program has not been reached (step 525: NO), the process returns to step 500, and the series of operations is repeated. On the other hand, when the end of the program has been reached in step 525 (step 525: YES), the instruction execution apparatus 200 terminates the process.

The flowchart shown in FIG. 6 shows the details of the operations in step 505 shown in FIG. 5, and the operations are performed by the memory reservation unit 205 for each method included in a class file loaded into the memory. A process shown in FIG. 6 is started from step 600 where the memory reservation unit 205 counts the number n of instructions to be replaced, i.e., instructions to jump backward, by scanning the bytecode stream of the method. Then, the memory reservation unit 205 determines whether the counted number n is positive (step 602). When the counted number n is not positive (step 602: NO), the process is terminated.

On the other hand, when the counted number n is positive (step 602: YES), the memory reservation unit 205 reserves an array including n elements of a predetermined size m on the memory and stores a pointer to the reserved array in a predetermined location A (step 605). The predetermined size m represents a size (for example, eight bytes) that is the sum of a size r1 of a memory area necessary for a counter operation that is the additional processing and a size r2 of a memory area necessary for copying a backward branch instruction that is an instruction to be replaced and the offset value, as described above. Moreover, the predetermined location A is, for example, a method structure storing information related to a method. In this case, it is assumed that an initial value of zero is set as the value of a counter to an area to be used for the additional processing out of a memory area of each element.

When the array has been reserved by the memory reservation unit 205, the instruction replacement unit 210 prepares a variable i indicating the index of an array that is currently processed and sets an initial value of zero to the variable i (step 610). Then, the instruction replacement unit 210 detects a backward branch instruction to be replaced by again scanning the bytecode stream of the method processed by the memory reservation unit 205 and copies the instruction, together with the offset information of the instruction, to the i-th element (step 615).

Then, the instruction replacement unit 210 replaces, with a special-purpose instruction (JBbackedge), the backward branch instruction in the bytecode stream copied to the i-th element and stores the value of the variable i indicating the index of the current element in a two-byte area following the backward branch instruction in the bytecode stream, i.e., an area where the offset of the backward branch instruction has been stored (step 620). Then, the instruction replacement unit 210 increments the variable i by one (step 625) and determines whether the variable i is equal to the number n of instructions to jump backward (step 630).

When the variable i is not equal to the number n of instructions to jump backward (step 630: NO), the process returns to step 615, and the instruction replacement unit 210 repeats the series of operations from step 615 to step 630 to perform replacement and copying of all the instructions to jump backward in the bytecode stream of the method. On the other hand, when the variable i is equal to the number n of instructions to jump backward in step 630 (step 630: YES), the instruction replacement unit 210 terminates the process.

The flowchart shown in FIG. 7 shows the details of the operation in step 515 shown in FIG. 5, as described above. A process shown in FIG. 7 is started by calling the special-purpose instruction handler 215. The additional processing execution unit 220 in the special-purpose instruction handler 215 reads a predetermined number of bytes of a piece of bytecode following the special-purpose instruction (JBbackedge) in the bytecode stream and sets the predetermined number of bytes of the piece of bytecode to a variable index (step 700). The predetermined number of bytes represents the size of the index of an element of an array, for example, two bytes.

Then, the additional processing execution unit 220 acquires the starting address Array of an array by reading a pointer to the array from the predetermined location A, for example, a method structure (step 705). Then, the additional processing execution unit 220 acquires the address Address of a memory area for the additional processing by computing an expression (Array+index*m) (step 710). In this case, m represents the size of an element and takes the value of the sum of the size r1 of a memory area necessary for a counter operation that is the additional processing and the size r2 of a memory area necessary for copying a backward branch instruction that is an instruction to be replaced and the offset value, as described above.

Then, the additional processing execution unit 220 uses the memory area specified by the address Address as a counter and increments the counter by one so as to count the number of executions of a backward branch instruction to be replaced (step 715). Furthermore, the replaced instruction execution unit 225 in the special-purpose instruction handler 215 reads the replaced original backward branch instruction, together with the offset information of the instruction, from an address acquired from an expression (Address+r1) (step 720). Then, the replaced instruction execution unit 225 performs processing similar to the original instruction referring to the original backward branch instruction and the offset information having been read (step 725). It should be noted that, at this time, since the program counter PC keeps pointing to an address where the original backward branch instruction in the bytecode stream has existed, the replaced instruction execution unit 225 can process the backward branch instruction directly using the value of the read offset. Then, the process is terminated.

In this manner, according to the instruction execution apparatus 200 according to the first embodiment, when a specific instruction to be monitored has been detected in a bytecode stream read into the memory, an additional memory area for the additional processing is reserved, and the detected specific instruction is replaced with a special-purpose instruction performing the additional processing and identification information for identifying the location of the additional memory area after being copied to a part of the reserved memory area. Thus, according to the instruction execution apparatus 200 according to the first embodiment, a hash table need not be referred to for acquiring the location of the additional memory area, and the overhead can be reduced.

Moreover, according to the instruction execution apparatus 200 according to the first embodiment, when the special-purpose instruction has been read from the bytecode stream, after the additional processing is performed using the memory area acquired from the identification information, processing similar to the specific instruction in the area is performed referring to the instruction. Thus, according to the instruction execution apparatus 200 according to the first embodiment, the additional processing can be performed without changing the behavior of an original program because the change of the behavior is limited only to the instruction execution apparatus 200 (in the embodiments, the layer of a Java® virtual machine).

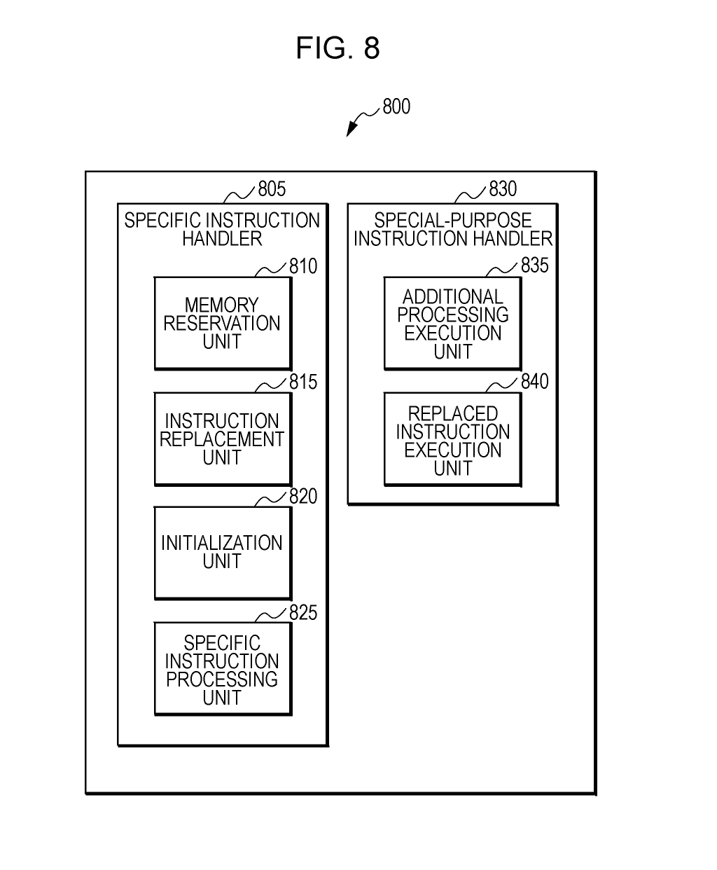

Second Embodiment FIG. 8 is a functional block diagram of an interpreter serving as an instruction execution apparatus 800 according to the second embodiment of the present invention. In the instruction execution apparatus 800 according to the second embodiment, a series of operations from reservation of an additional memory to replacement of an instruction are performed as some operations by a specific instruction handler that is called in response to a specific instruction (in the embodiments, a backward branch instruction). Thus, for the first execution of the specific instruction, the additional processing (in the embodiments, a counter operation) performed by a special-purpose instruction is not performed. Accordingly, the additional processing for the first execution of the specific instruction is performed by the specific instruction handler as initialization.

The interpreter serving as the instruction execution apparatus 800 according to the second embodiment includes a specific instruction handler 805. The specific instruction handler 805 includes a memory reservation unit 810, an instruction replacement unit 815, an initialization unit 820, and a specific instruction processing unit 825. The interpreter serving as the instruction execution apparatus 800 according to the second embodiment further includes a special-purpose instruction handler 830. The special-purpose instruction handler 830 includes an additional processing execution unit 835 and a replaced instruction execution unit 840. Since the special-purpose instruction handler 830 does not differ in functions from the aforementioned special-purpose instruction handler 215 in the instruction execution apparatus 200 according to the first embodiment, the description of the special-purpose instruction handler 830 is omitted here to avoid repetition.

The specific instruction handler 805 is called in response to reading of the bytecode of a specific instruction from the bytecode stream of a method included in a class file by the instruction execution apparatus 800. In this case, it is assumed that the specific instruction handler 805 has a variable counterArraySize indicating the current number of elements of an array reserved by the memory reservation unit 810 described below, and zero is set to the variable counterArraySize as an initial value.

The memory reservation unit 810 checks the number of elements of an array that is currently reserved by referring to the value of the variable counterArraySize. When the value of the variable counterArraySize is zero, i.e., an array is first reserved, an array including one element of a predetermined size m is reserved on the memory. The memory reservation unit 810 further stores the location information of the reserved array, for example, a pointer to the array, in association with a corresponding method. For example, the memory reservation unit 810 stores the location information of the array in a method structure. The memory reservation unit 810 further increments the variable counterArraySize by one.

In this case, a part of a memory area of an element is used as a work area for the additional processing, i.e., a counter, as described in relation to the instruction execution apparatus 200 according to the first embodiment. Moreover, another part of the memory area of the element is used as an area to which a specific instruction to which the element is allocated, i.e., a backward branch instruction, and an offset to a jump target are copied. Thus, the predetermined size m of an element is at least eight bytes, the sum of the number of bytes of a counter (for example, four bytes) and the size of information of a backward branch instruction (for example, two bytes for a jump instruction and two bytes for an offset to a jump target).

Moreover, when the value of the variable counterArraySize is not zero, the memory reservation unit 810 increments the variable counterArraySize by one to expand the array to an array including as many elements of the predetermined size m as the value of the variable counterArraySize.

The instruction replacement unit 815 copies a specific instruction calling the specific instruction handler 805 in a bytecode stream to a corresponding element of an array reserved for the specific instruction by the memory reservation unit 810, the index value of the element being counterArraySize-1. In the embodiments, since a specific instruction is a backward branch instruction, the instruction replacement unit 815 copies a backward branch instruction, together with an offset to a jump target, to a corresponding element of an array.

The instruction replacement unit 815 further replaces the copied backward branch instruction in the bytecode stream with identification information for identifying the location of the element of the array allocated to the jump instruction and a special-purpose instruction performing the additional processing. When the index of the array is used as the identification information, the value of the index is counterArraySize-1. Since the special-purpose instruction is the same as a special-purpose instruction described in relation to the first embodiment, the description of the special-purpose instruction is omitted here. In the second embodiment as well, it is assumed that the name of the special-purpose instruction is JBbackedge.

The initialization unit 820 performs the additional processing for a specific instruction in a bytecode stream, i.e., counting of the number of executions of a backward branch instruction, using an area of an element reserved by the memory reservation unit 810, the index value of the element being counterArraySize-1. The specific instruction handler 805 is called just once for each specific instruction in a bytecode stream at the time of the first execution of the instruction before the instruction is replaced with a special-purpose instruction. Thus, the aforementioned counter operation by the initialization unit 820 is to initialize a counter for each specific instruction in a bytecode stream to one.

The specific instruction processing unit 825 performs processing originally defined for a specific instruction. That is, when a specific instruction is a backward branch instruction, the specific instruction processing unit 825 performs an original jump operation defined for a backward branch instruction.

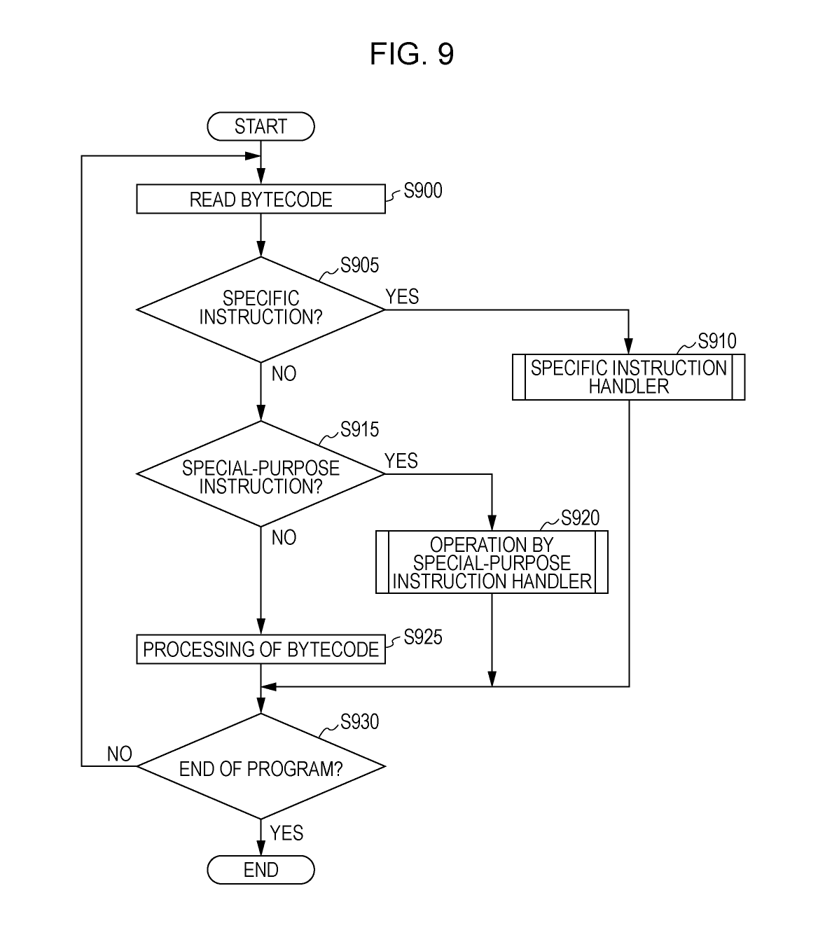

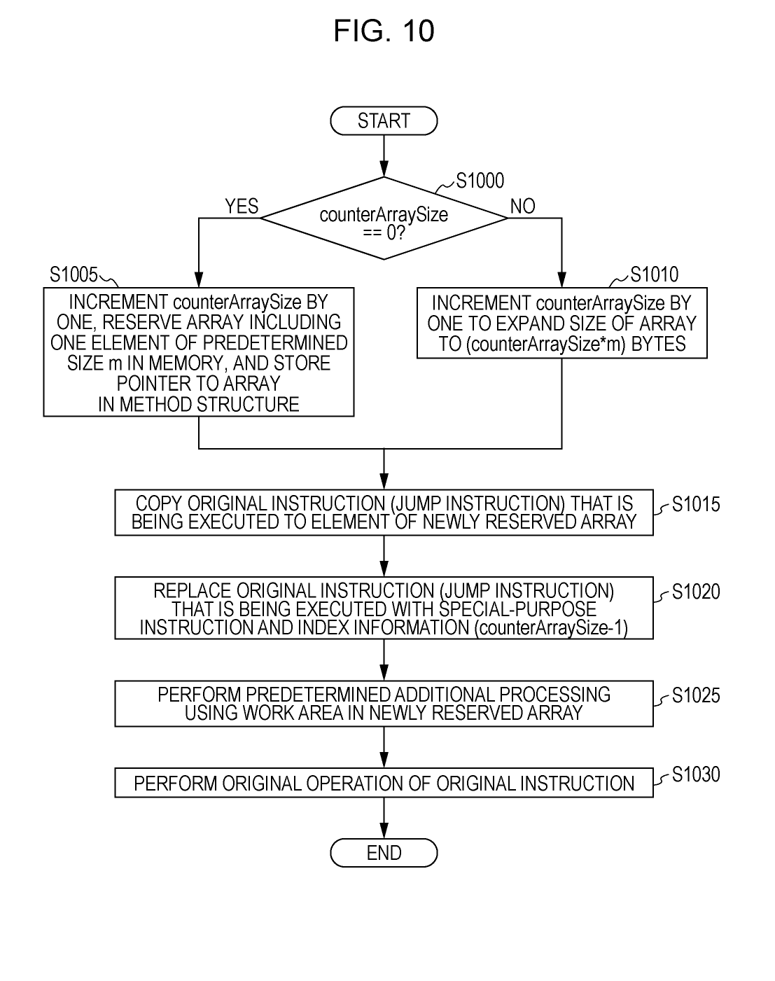

The flow of a process performed by the instruction execution apparatus 800 according to the second embodiment of the present invention will next be described referring to FIGS. 9 and 10. FIG. 9 is a flowchart showing the overall flow of the process for executing bytecode by the instruction execution apparatus 800 according to the second embodiment of the present invention. FIG. 10 is a flowchart showing an operation (S910) by the specific instruction handler 805 shown in FIG. 9.

The process shown in FIG. 9 is started from step 900 where, when a new class file has been loaded into the memory, the instruction execution apparatus 800 sequentially reads pieces of bytecode from a bytecode stream for each method in the class file. Then, the instruction execution apparatus 800 determines whether the read piece of bytecode is a specific instruction, in the embodiments, a backward branch instruction (step 905). When the read piece of bytecode is a specific instruction (step 905: YES), the instruction execution apparatus 800 processes the specific instruction by calling the specific instruction handler 805 (step 910). The details of the operation by the specific instruction handler 805 will be described below referring to FIG. 10.

When the read piece of bytecode is not a specific instruction in step 905, the instruction execution apparatus 800 determines whether the read piece of bytecode is a special-purpose instruction, in the embodiments, JBbackedge (step 915). When the read piece of bytecode is a special-purpose instruction (step 915: YES), the instruction execution apparatus 800 processes the special-purpose instruction by calling the special-purpose instruction handler 830 (step 920). The details of the operation by the special-purpose instruction handler 830 are the same as those of the operation by the special-purpose instruction handler 215 described referring to FIG. 7, and thus the description is omitted here.

When the read piece of bytecode is not a special-purpose instruction in step 915, the instruction execution apparatus 800 performs an operation defined in the read piece of bytecode (step 925). From step 910, 920, or 925, the process proceeds to step 930 where the instruction execution apparatus 800 determines whether the end of the program has been reached, i.e., the next piece of bytecode exists (step 930). When the end of the program has not been reached (step 930: NO), the instruction execution apparatus 800 causes the process to return to step 900 and repeats the series of operations. On the other hand, when the end of the program has been reached in step 930, the instruction execution apparatus 800 terminates the process.

FIG. 10 is a flowchart showing the flow of the operation by the handler 805 of a specific instruction, i.e., a backward branch instruction. A process shown in FIG. 10 is started from step 1000 where the memory reservation unit 810 determines whether the value of counterArraySize indicating the number of elements of an array that is currently reserved is zero. When the value of counterArraySize is zero (step 1000: YES), the memory reservation unit 810 increments counterArraySize by one, reserves an array including one element of a predetermined size m in the memory, and stores a pointer to the array in a method structure of a method that is currently processed (step 1005). In this case, a method that is currently processed is a method including a specific instruction calling the specific instruction handler 805.

On the other hand, when the value of counterArraySize is not zero in step 1000 (step 1000: NO), the memory reservation unit 810 increments counterArraySize by one to expand the size of an array having already been reserved on the memory to a size acquired by multiplying the value of counterArraySize by the predetermined size m of an element (step 1010). Then, the process proceeds from step 1005 or 1010 to step 1015 where the instruction replacement unit 815 copies a backward branch instruction that is the original specific instruction that is being executed to an element of the newly reserved array, the index value of the element being counterArraySize-1.

Then, the instruction replacement unit 815 replaces the backward branch instruction, which is the original specific instruction in a bytecode stream, with a special-purpose instruction JBbackedge and the index information (counterArraySize-1) of the element of the array allocated to the backward branch instruction (step 1020). Then, the initialization unit 820 performs the operation of counting the number of executions of the backward branch instruction, the operation being the predetermined additional processing, using, as a counter, an area of the element of the newly reserved array, the index value of the element being counterArraySize-1 (step 1025). Then, the specific instruction processing unit 825 performs an operation originally defined in the backward branch instruction, which is the original specific instruction (step 1030). Then, the process is terminated.

In this manner, according to the instruction execution apparatus 800 according to the second embodiment, as is the case with the instruction execution apparatus 200 according to the first embodiment, since a hash table need not be referred to for acquiring the location of an additional memory area, the overhead can be reduced. Moreover, the additional processing can be performed without changing the behavior of an original program because the change of the behavior is limited only to the instruction execution apparatus 800 (in the embodiments, the layer of a Java® virtual machine).

Moreover, according to the instruction execution apparatus 800 according to the second embodiment, when a specific instruction (for example, a backward branch instruction) in a bytecode stream is actually executed, a memory area for the additional processing (for example, a counter operation of counting the number of executions of a backward branch instruction) is allocated to the specific instruction. Thus, there is no waste of a memory due to allocation of a memory area for the additional processing to a specific instruction in the bytecode stream that is not actually executed.

In the instruction execution apparatus 800 according to the second embodiment, when the instruction execution apparatus 800 operates in a multi-threaded environment such as a Java® virtual machine, a problem exists in a conflict between threads. That is, in a multi-threaded environment, in response to a request from one thread for processing a specific instruction in a bytecode stream, while the specific instruction handler 805 is rewriting the specific instruction, another thread can request processing of the specific instruction. Thus, an instruction execution apparatus addressing such a conflict problem will now be described as an instruction execution apparatus 1100 according to a third embodiment.

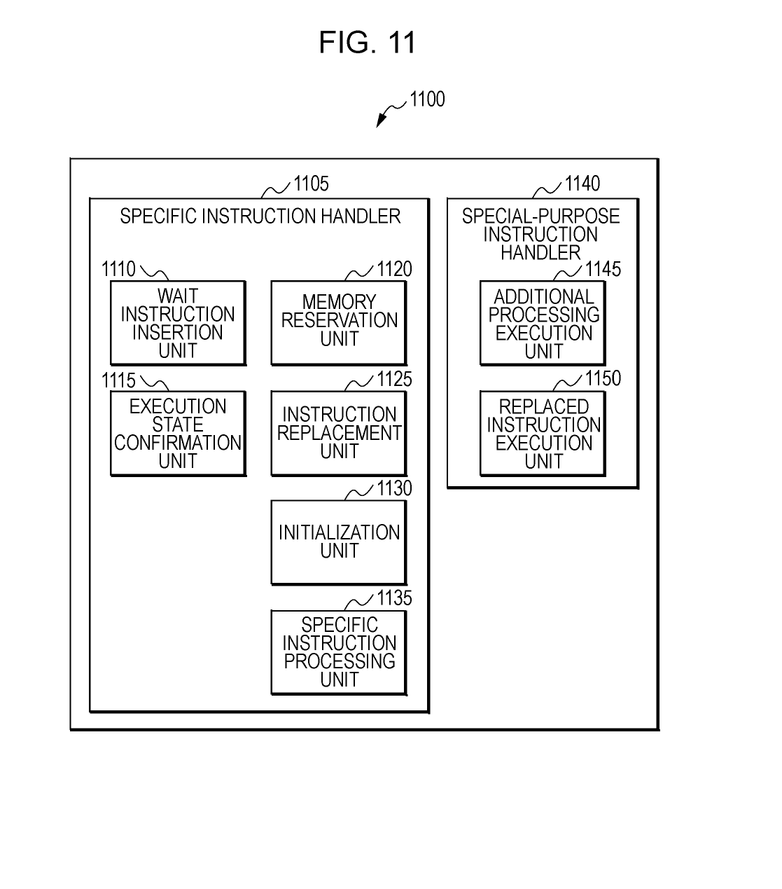

Third Embodiment FIG. 11 is a functional block diagram of an interpreter serving as the instruction execution apparatus 1100 according to the third embodiment of the present invention. The interpreter serving as the instruction execution apparatus 1100 according to the third embodiment includes basically the same functional components as the interpreter serving as the instruction execution apparatus 800 according to the second embodiment. However, a specific instruction handler 1105 according to the third embodiment newly includes a wait instruction insertion unit 1110 and an execution state confirmation unit 1115. Thus, in the following description, the wait instruction insertion unit 1110 and the execution state confirmation unit 1115 newly added will be mainly described.

When the instruction execution apparatus 1100 has read the bytecode of a specific instruction from a bytecode stream on the basis of a request from one thread, the specific instruction handler 1105 is called in response to this operation. The called specific instruction handler 1105 first causes the wait instruction insertion unit 1110 to start a process. After saving the specific instruction in the bytecode stream, the specific instruction having called the specific instruction handler 1105, in a temporary save place, the wait instruction insertion unit 1110 replaces the specific instruction with a wait instruction to request a wait for execution of the process. The temporary save place can be an area on the memory or a register. It is assumed that, when the specific instruction is a backward branch instruction, offset information indicating the jump target of the instruction is also saved.

The execution state confirmation unit 1115 confirms whether another thread that is executing the specific instruction in the bytecode stream, the specific instruction having called the specific instruction handler 1105, exists. Confirmation of whether such another thread exists can be obtained by acquiring a list of current threads and examining the location of bytecode that is being executed for each thread.

It is assumed that a memory reservation unit 1120 in the instruction execution apparatus 1100 according to the third embodiment starts its operation on the condition that another thread that is executing the aforementioned specific instruction does not exist on the basis of the result of the confirmation by the execution state confirmation unit 1115.

Moreover, it is assumed that an instruction replacement unit 1125 in the instruction execution apparatus 1100 according to the third embodiment copies a specific instruction stored in a temporary save place to an element of an array reserved for the instruction by the memory reservation unit 1120 and replaces a wait instruction in a bytecode stream embedded by the wait instruction insertion unit 1110 with a special-purpose instruction and the index of the element of the array. The respective functions of the other components do not differ from those of the instruction execution apparatus 800 according to the second embodiment, as described above, and thus the description is omitted here.

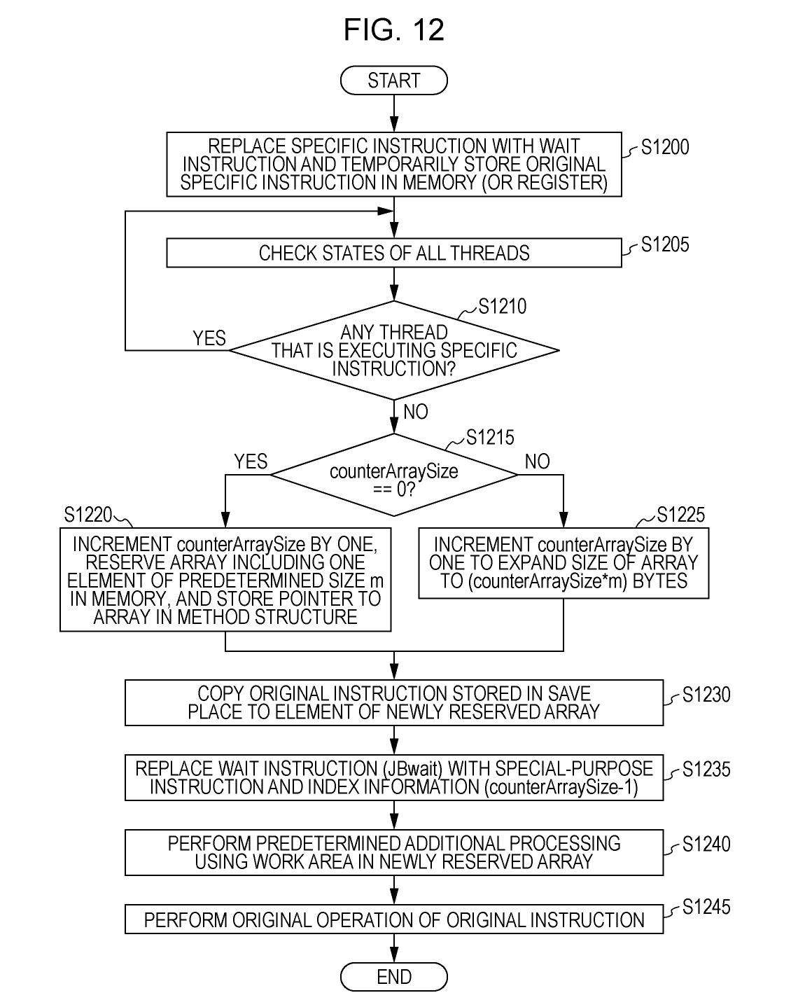

The flow of an operation by the specific instruction handler 1105 according to the third embodiment of the present invention will next be described referring to FIG. 12. The flow of the overall process performed by the instruction execution apparatus 1100 according to the third embodiment of the present invention and the flow of the process performed by a special-purpose instruction handler 1140 are basically the same as the flow of the process performed by the instruction execution apparatus 800 according to the second embodiment of the present invention described referring to FIG. 9 and the flow of the process performed by the special-purpose instruction handler 215 in the instruction execution apparatus 200 according to the first embodiment of the present invention described referring to FIG. 7, respectively. Thus, the description is omitted here.

A process shown in FIG. 12 is started when the specific instruction handler 1105 has been called in response to a backward branch instruction that is a specific instruction in a bytecode stream on the basis of a request from one thread. The wait instruction insertion unit 1110 replaces the backward branch instruction in the bytecode stream, the specific instruction having called the specific instruction handler 1105, with a wait instruction JBwait to request a wait for execution of the process and stores the original backward branch instruction, together with the offset information of the instruction, in a temporary save place such as a memory or a register (step 1200).

Then, the execution state confirmation unit 1115 confirms the current execution states of all threads, i.e., the location of bytecode that is being executed (step 1205) and then confirms whether another thread that is executing the backward branch instruction in the bytecode stream, the instruction having called the specific instruction handler 1105, exists (step 1210). When such another thread exists (step 1210: YES), the process returns to step 1205, and the series of operations is repeated.

On the other hand, when another thread that is executing the aforementioned backward branch instruction does not exist in step 1210, the process proceeds to step 1215 where the memory reservation unit 1120 determines whether the value of counterArraySize indicating the number of elements of an array that is currently reserved is zero. When the value of counterArraySize is zero (step 1215: YES), the memory reservation unit 1120 increments counterArraySize by one, reserves an array including one element of a predetermined size m in the memory, and stores a pointer to the array in a method structure of a method that is currently processed (step 1220). In this case, a method that is currently processed is a method including an original specific instruction calling the specific instruction handler 1105.

On the other hand, when the value of counterArraySize is not zero in step 1215, the memory reservation unit 1120 increments counterArraySize by one to expand the size of an array having already been reserved on the memory to a size acquired by multiplying the value of counterArraySize by the predetermined size m of an element (step 1225). Then, the process proceeds from step 1220 or 1225 to step 1230 where the instruction replacement unit 1125 copies the backward branch instruction, which is the original specific instruction stored in the temporary save place, together with the offset information, to an element of the newly reserved array, the index value of the element being counterArraySize-1.

Then, the instruction replacement unit 1125 replaces the wait instruction JBwait in the bytecode stream with a special-purpose instruction JBbackedge and the index information (counterArraySize-1) of the element of the array allocated to the backward branch instruction (step 1235). Then, the initialization unit 1130 performs the operation of counting the number of executions of the backward branch instruction, the operation being the predetermined additional processing, using, as a counter, an area of the element of the newly reserved array, the index value of the element being counterArraySize-1 (step 1240). Then, the specific instruction processing unit 1135 performs an operation originally defined in the backward branch instruction, which is the original specific instruction (step 1245). Then, the process is terminated.

In this manner, according to the specific instruction handler 1105 in the instruction execution apparatus 1100 according to the third embodiment, since a specific instruction to be rewritten is first replaced with a wait instruction, any thread newly executing the specific instruction does not exist. Moreover, when another thread that is executing the specific instruction to be rewritten does not exist, replacement of the specific instruction is started. Thus, the problem of conflicts in a multi-threaded environment is solved.

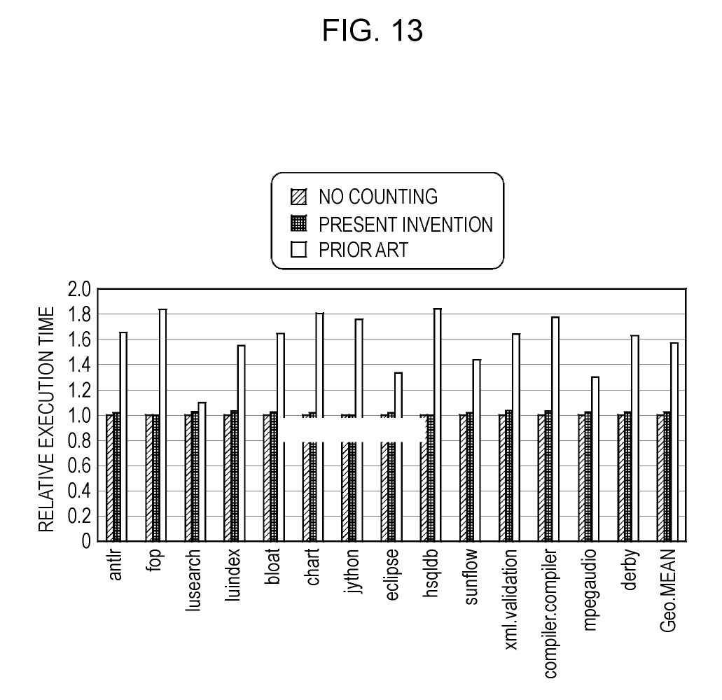

The effect of a reduction in the overhead according to the present invention will next be examined referring to FIG. 13. A graph shown in FIG. 13 shows the results of experiments in comparison of the respective overheads of the following three cases due to a counter operation of counting the number of executions of a backward branch instruction: a case where such additional processing is not performed, a case where a prior art is used, and a case where the present invention is used. The ordinate represents relative execution time, and the abscissa represents the individual program names of a benchmark suite called DaCapo benchmarksuite. Regarding any of the programs, according to the present invention, the overhead due to the counter operation can be disregarded, as can be seen from the graph shown in FIG. 13.

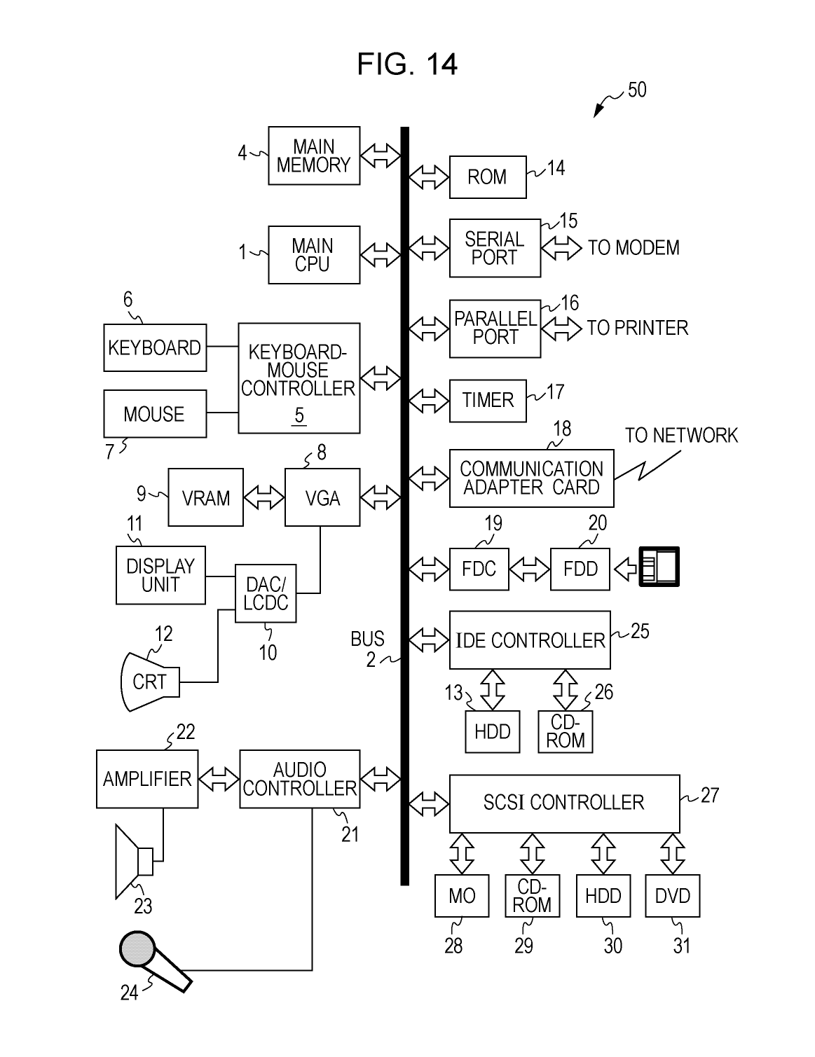

FIG. 14 is a diagram showing exemplary hardware components of a computer 50 according to the embodiments. The computer 50 includes a main CPU (central processing unit) 1 and a main memory 4 connected to a bus 2. Hard disk units 13 and 30 and removable storages (external storage systems in which a recording medium can be changed) such as CD-ROM units 26 and 29, a flexible disk unit 20, an MO unit 28, and a DVD unit 31 are connected to the bus 2 via a flexible disk controller 19, an IDE controller 25, and an SCSI controller 27.

Storage media such as a flexible disk, an MO, a CD-ROM, and a DVD-ROM are inserted into the removable storages. The code of a computer program for carrying out the present invention by issuing instructions to the CPU 1 and the like, cooperating with an operating system, can be recorded in, for example, these storage media, the hard disk units 13 and 30, and a ROM 14. That is, a bytecode execution program that is installed in the computer 50 and causes the computer 50 to function as the instruction execution apparatus 200, 800, or 1100 can be recorded in the various types of storage units described above.

The bytecode execution program causing the computer 50 to function as the instruction execution apparatus 200 includes a memory reservation module, an instruction replacement module, and a special-purpose instruction handler module. These modules cause the CPU 1 and the like to cause the computer 50 to function as the memory reservation unit 205, the instruction replacement unit 210, and the special-purpose instruction handler 215. Moreover, the special-purpose instruction handler module includes an additional processing execution module and a replaced instruction execution module. These modules cause the CPU 1 and the like to cause the computer 50 to function as the additional processing execution unit 220 and the replaced instruction execution unit 225.

The bytecode execution program causing the computer 50 to function as the instruction execution apparatus 800 includes a specific instruction handler module and a special-purpose instruction handler module. These modules cause the CPU 1 and the like to cause the computer 50 to function as the specific instruction handler 805 and the special-purpose instruction handler 830. Moreover, the specific instruction handler module includes a memory reservation module, an instruction replacement module, an initialization module, and a specific instruction processing module. These modules cause the CPU 1 and the like to cause the computer 50 to function as the memory reservation unit 810, the instruction replacement unit 815, the initialization unit 820, and the specific instruction processing unit 825. Moreover, the special-purpose instruction handler module includes an additional processing execution module and a replaced instruction execution module. These modules cause the CPU 1 and the like to cause the computer 50 to function as the additional processing execution unit 835 and the replaced instruction execution unit 840.

The bytecode execution program causing the computer 50 to function as the instruction execution apparatus 1100 includes a specific instruction handler module and a special-purpose instruction handler module. These modules cause the CPU 1 and the like to cause the computer 50 to function as the specific instruction handler 1105 and the special-purpose instruction handler 1140. Moreover, the specific instruction handler module includes a wait instruction insertion module, an execution state confirmation module, a memory reservation module, an instruction replacement module, an initialization module, and a specific instruction processing module. These modules cause the CPU 1 and the like to cause the computer 50 to function as the wait instruction insertion unit 1110, the execution state confirmation unit 1115, the memory reservation unit 1120, the instruction replacement unit 1125, the initialization unit 1130, and the specific instruction processing unit 1135. Moreover, the special-purpose instruction handler module includes an additional processing execution module and a replaced instruction execution module. These modules cause the CPU 1 and the like to cause the computer 50 to function as the additional processing execution unit 1145 and the replaced instruction execution unit 1150. The computer program can be compressed and divided into a plurality of pieces to be recorded in a plurality of media.

The computer 50 receives input from input devices such as a keyboard 6 and a mouse 7 via a keyboard-mouse controller 5. The computer 50 receives input from a microphone 24 and outputs sounds from a speaker 23 via an audio controller 21. The computer 50 is connected to a display unit 11 for presenting visual data to users via a graphics controller 10. The computer 50 can be connected to a network and can communicate with another computer. The connection can be via a communication adapter card 18, such as, an Ethernet (registered trademark) card or a token ring card.

It will be appreciated from the foregoing description that the computer 50 according to the embodiments can be implemented via general information processors, such as a personal computer, a workstation, and a mainframe, or the combination of them. The aforementioned components are illustrative, and all the components are not essential components of the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

That which is claimed is:

1. An instruction execution apparatus performing additional processing requiring a memory area on execution of a specific instruction to be monitored included in an instruction stream including instructions to be executed by a predetermined execution system on a computer, the instruction execution apparatus comprising:
a memory reservation unit reserving the memory area for the additional processing for the specific instruction included in the instruction stream read on a memory;
an instruction replacement unit copying the specific instruction to the reserved memory area and replacing the specific instruction with a special-purpose instruction performing the additional processing and identification information for identifying a location of the memory area;
an additional processing execution unit acquiring, upon reading the special-purpose instruction in the instruction stream, the memory area from the identification information having been subjected to replacement together with the special-purpose instruction and performing the additional processing using the memory area; and
a replaced instruction execution unit performing same processing as processing performed by the specific instruction referring to the specific instruction copied to the acquired memory area.

2. The instruction execution apparatus according to claim 1, wherein the additional processing execution unit and the replaced instruction execution unit are implemented as a handler of the special-purpose instruction to be called in response to the special-purpose instruction.

3. The instruction execution apparatus according to claim 2, wherein the execution system is a Java® virtual machine.

4. The instruction execution apparatus according to claim 2, wherein the instruction stream read on the memory is a bytecode stream of each method included in a class file, the bytecode stream including at least one said specific instruction.

5. The instruction execution apparatus according to claim 2, wherein the memory reservation unit reserves, for the method in the class file, the memory area as an array including as many elements as the number of at least one said specific instruction and stores location information of the reserved array in association with the method.

6. The instruction execution apparatus according to claim 2, wherein the instruction replacement unit copies each of at least one said specific instruction included in the bytecode stream to a corresponding one of the elements of the array and replaces the specific instruction with the special-purpose instruction and index information of the array allocated to the specific instruction.

7. The instruction execution apparatus according to claim 2, wherein the specific instruction is a backward branch instruction and the additional processing requiring the memory area is a counter operation of counting the number of executions of the backward branch instruction.

8. The instruction execution apparatus according to claim 7, wherein offset information indicating a jump target of the backward branch instruction in the bytecode stream is replaced with the index information of the array.

9. The instruction execution apparatus according to claim 7, wherein, after the index information of the array is embedded in an instruction name of the special-purpose instruction, the backward branch instruction in the bytecode stream is replaced with the special-purpose instruction.

10. The instruction execution apparatus according to claim 2, wherein the memory reservation unit and the instruction replacement unit are implemented as parts of a handler of the specific instruction to be called in response to the specific instruction, and the handler of the specific instruction processes the specific instruction and initializes the reserved memory area.

11. The instruction execution apparatus according to claim 10, wherein the instruction execution apparatus operates in a multi-threaded environment, the handler of the specific instruction further includes a wait instruction insertion unit replacing the specific instruction with a wait instruction to request a wait for execution of processing and storing the specific instruction in a temporary save place upon reading the specific instruction in the instruction stream on the basis of a request from one thread.

12. The instruction execution apparatus according to claim 10, wherein an execution state confirmation unit confirming whether another thread that is executing the specific instruction in the instruction stream exists, the memory reservation unit starts an operation on condition that another thread that is executing the specific instruction does not exist.

13. The instruction execution apparatus according to claim 10, wherein the instruction replacement unit copies the specific instruction stored in the temporary save place to the memory area and replaces the wait instruction in the bytecode stream with the special-purpose instruction and the identification information.

14. An instruction execution method to be executed by a computer, the instruction execution method performing additional processing requiring a memory area on execution of a specific instruction to be monitored included in an instruction stream including instructions to be executed by a predetermined execution system on the computer, the instruction execution method comprising the steps of:
reserving the memory area for the additional processing for the specific instruction included in the instruction stream read on a memory;
copying the specific instruction to the reserved memory area and replacing the specific instruction with a special-purpose instruction performing the additional processing and identification information for identifying a location of the memory area;
acquiring, upon reading the special-purpose instruction in the instruction stream, the memory area from the identification information having been subjected to replacement together with the special-purpose instruction and performing the additional processing using the memory area; and
performing same processing as processing performed by the specific instruction referring to the specific instruction copied to the acquired memory area.

15. The method according to claim 14, wherein reserving the memory area comprises reserving the memory area as an array including as many elements as the number of at least one specific instruction

16. The method according to claim 15, further comprises:
storing a location information of the reserved array.

17. The method according to claim 14, wherein replacing the specific instruction with the special-purpose instruction includes index information of the array allocated to the specific instruction.

18. An instruction execution program product to be executed on a computer, the instruction execution program product performing additional processing requiring a memory area on execution of a specific instruction to be monitored included in an instruction stream including instructions to be executed by a predetermined execution system on the computer, the instruction execution program product causing the computer to execute the steps of:
reserving the memory area for the additional processing for the specific instruction included in the instruction stream read on a memory;
copying the specific instruction to the reserved memory area and replacing the specific instruction with a special-purpose instruction performing the additional processing and identification information for identifying a location of the memory area;
acquiring, upon reading the special-purpose instruction in the instruction stream, the memory area from the identification information having been subjected to replacement together with the special-purpose instruction and performing the additional processing using the memory area; and
performing same processing as processing performed by the specific instruction referring to the specific instruction copied to the acquired memory area.
